(19) United States
(12) Patent Application Publication
(10) Pub. No.: US 2013/0017846 A1
(43) Pub. Date: Jan. 17, 2013

(54) Systems and Methods for Smart Texting on Mobile Devices

(71) Applicant: Donald Werner Schoppe, Apex, NC (US)

(72) Inventor: Donald Werner Schoppe, Apex, NC (US)

(73) Assignee: HTC CORPORATION, Taoyuan City, Taoyuan County (TW)

(21) Appl. No.: 13/182,746

(22) Filed: Jul. 14, 2011

(51) Int. Cl. H04W 4/14

(52) U.S. Cl. 455/466

(57) ABSTRACT

In one embodiment, a mobile device that includes a message library, a display screen, a memory, and a processor. The message library includes a plurality of predetermined text messages, and the memory is encoded with logic. The processor is configured to execute the logic to receive a first user input corresponding to user selection of an intended recipient, and responsive to receipt of the first user input, present on the display screen the plurality of predetermined text messages automatically ordered based on the applicability of each message at a given instance of time.

### TECHNICAL FIELD

The present disclosure generally relates to text messaging using mobile devices.

### BACKGROUND

Over the years, portable handheld devices, such as mobile devices (e.g., smartphones) have become prevalent. With the rapid development in circuit manufacturing and communications technology, mobile devices continue to shrink in size, with a concomitant reduction in the size of their displays and input mechanisms. For instance, some mobile devices may be so small that they have no alpha character input mechanism (e.g., button-keyboards). Some devices even lack a numeric keyboard, prohibiting methods such as T9 (text on 9 keys) to be implemented to enter characters. Nor does voice-to-text input offer a solution when processor (e.g., CPU) capacity is limited and/or acoustical characteristics are poor.

### SUMMARY

In one embodiment, a mobile device that includes a message library, a display screen, a memory, and a processor. The message library includes a plurality of predetermined text messages, and the memory is encoded with logic. The processor is configured to execute the logic to receive a first user input corresponding to user selection of an intended recipient, and responsive to receipt of the first user input, present on the display screen the plurality of predetermined text messages automatically ordered based on the applicability of each message at a given instance of time.

Another embodiment is a method that comprises receiving a plurality of predetermined text messages, storing the plurality of predetermined text messages in a message library, receiving a first user input corresponding to user selection of an intended recipient, automatically ordering, by a processor, the plurality of predetermined text messages based on the applicability of each message at a given instance of time, and responsive to receiving the first user input, presenting on a display screen of a mobile device the processor-ordered plurality of predetermined text messages.

Another embodiment is a system that comprises a message library, the message library comprising a plurality of predetermined text messages. The system further comprises a display screen, a memory encoded with logic, and a processor configured to execute the logic to receive a first user input corresponding to user selection of an intended recipient, automatically order the plurality of predetermined text messages based on the applicability of each message at a given instance of time, and responsive to receiving the first user input, present on the display screen the ordered plurality of predetermined text messages.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A is a schematic diagram that depicts an example environment where mobile device users are texting each other as friends using an embodiment of a smart texting system.

FIG. 1B is a block diagram that depicts an example embodiment of a smart texting system residing within, or embodied as, a mobile device of each user depicted in FIG. 1A with ordered text messages presented on the display screen.

FIG. 2A is a schematic diagram that depicts an example environment where mobile device users are texting each other as business colleagues using an embodiment of a smart texting system.

FIG. 2B is a block diagram that depicts an example embodiment of a smart texting system residing within, or embodied as, a mobile device of each user depicted in FIG. 2A with ordered text messages presented on the display screen.

FIG. 3 is a schematic diagram that illustrates an example environment and process flow in which an embodiment of a smart texting system is loaded with a plurality of predetermined text messages.

FIG. 4 is a block diagram of an example embodiment of a smart texting system configured as a mobile device.

FIG. 5 is a flow diagram that illustrates an embodiment of a smart texting method.

FIG. 6 is a block diagram that illustrates an example embodiment of a message library of a smart texting system comprising a plurality of predetermined text messages with a statistical indication of historical usage.

FIGS. 7A-7B are block diagrams that illustrates an example embodiment of message libraries of a smart texting system comprising a plurality of text messages that are ordered based on recipient.

FIG. 8 is a flow diagram that illustrates another embodiment of a smart texting method.

### DETAILED DESCRIPTION

Having summarized various aspects of the present disclosure, reference will now be made in detail to the description of the disclosure as illustrated in the drawings. While the disclosure will be described in connection with these drawings, there is no intent to limit it to the embodiment or embodiments disclosed herein. On the contrary, the intent is to cover all alternatives, modifications and equivalents included within the spirit and scope of the disclosure as defined by the appended claims.

Many small mobile devices, such as watch phones or other smart phones, have limited, if any, alpha character input mechanisms. Such limitations prevent or at least significantly impair the ability to send text messages. In certain embodiments described herein, smart texting systems and methods (herein, collectively smart texting system(s)) are disclosed that provide a solution that enables text messaging capabilities when alpha character input is limited or non-existent. Such smart texting systems are at least equipped with a mechanism to enable a user to scroll and select items from a list displayed on a display screen. It should be appreciated that, though certain embodiments are described below in the context of limited or no alpha character input, some embodiments, such as for those physically impaired, may have mobile devices with such capabilities and still benefit from the embodiments disclosed herein.

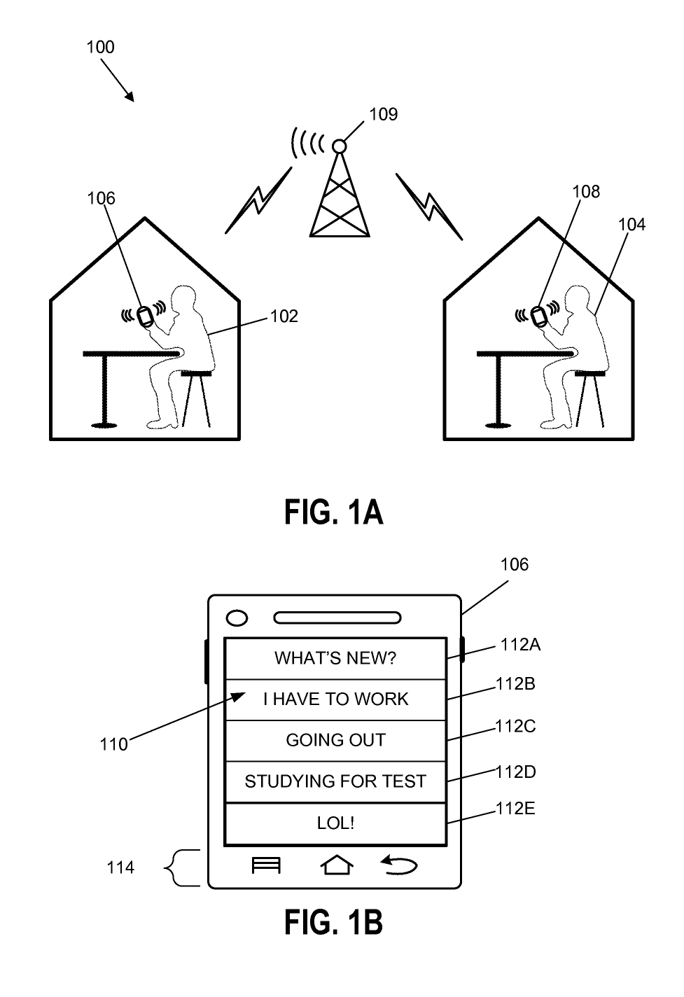

Reference is made to FIG. 1A, which shows a communications network 100 including two mobile device users 102 and 104 texting each other using mobile devices 106 and 108, respectively. The mobile devices 106 and 108 are depicted as smart phones, though other communication devices may be used as well. The users 102 and 104 communicate predetermined text messages (and in some embodiments, user-inputted text messages via a touch-pad, displayed alphanumeric keyboard) using mobile devices 106 and 108, respectively, the predetermined text messages communicated via one or more networks that include, in one embodiment, one or more cell phone towers 109. For the sake of simplicity, it is assumed that the mobile devices 106 and 108 are the same models with limited alpha character input mechanisms, though not limited to use of the same models or the same limited functionality as indicated above.

FIG. 1B depicts the mobile device 106 (where the same description applies to the mobile device 108, and hence omitted here for brevity). The mobile device comprises a touch-type display screen 110 that enables the user 102 to scroll through a plurality of predetermined text messages 112A-112E (collectively, referred to as predetermined text messages 112) presented on the display screen 110. The mobile device 106 also comprises various function buttons 114 on the face of the device 106. Although described in the context of predetermined text messages, in some embodiments, such as where limited alpha character input is enabled, a user may add user-crafted (created) messages to the existing list of predetermined text messages. In one embodiment, the user 102 may scroll through the messages 112 by lightly touching and swiping his or her finger (or stylus or pen) across the display screen 110. The scrolling action may be implemented with or without an advancing highlight surrounding a given message or cursor overlapping a given message, or the advancing of each message toward the top or bottom of the display screen 110 to the point where one message “disappears” from the screen and a new one emerges. Selection of a particular one of the text messages 112 may be achieved by tapping a highlighted text message. In some embodiments, selection may be achieved by the user tapping a cursor that is overlaid on a desired message, or in some embodiments, other known mechanisms may be that may or may not involve non-screen buttons.

In some embodiments, a scroll icon (not shown) may be presented on the display screen 110 or elsewhere on the device 106 (e.g., as a function button 114), where the user navigates through the list of predetermined text messages through manipulation (e.g., touching) of the scroll icon (or button).

The predetermined text messages 112 are ordered by an embodiment of a smart texting system. In this example, the smart texting system orders the predetermined text messages based on the applicability of each message at a given instance in time—in this example, based on intended recipient information. In other words, an embodiment of the smart texting system accesses a message library contained within the mobile device and orders a plurality of predetermined text messages such that the messages most applicable to the given instant of time (e.g., here, messages relevant to texting a friend) are presented at the top of the list of messages in the display screen 110, whereas least applicable messages (e.g., those used for intended recipients that are, say, business colleagues) are presented toward the bottom of the list of presented messages selectable through the display screen 110. For instance, a friend is not likely to text another friend (or likewise, a family member to another member of the family) with messages requesting a raise or asking for time off. Accordingly, the predetermined text messages 112 more applicable to the given relationship of texting users in this example include “what's new?” 112A, “I have to work” 112B, “Going out” 112C, “Studying for a test” 112D, and “LOL” 112E. It should be appreciated that these messages are for illustrative purposes only, and that other messages are contemplated to be within the scope of the disclosure.

In some embodiments, the choice of predetermined text messages 112 presented on the display screen 110 may be limited to a threshold number of most likely candidate messages. In other words, a threshold number of candidate predetermined text messages may be extracted from the message library and presented on the display screen 110. In such an embodiment, the threshold may be determined by historical usage. For instance, the smart texting system may track the frequency by which certain text messages are selected (or the frequency certain text messages are selected for a given recipient). In one embodiment, the smart texting system may choose a mean or median frequency of usage (selection) as the threshold, though other criteria may be used for determining a threshold, such as via user designation (or entry) of such an option through a settings screen. Any messages that were selected in the past with a frequency less than the threshold are removed as candidates for display, and those messages with a selection frequency above or equal to the threshold are displayed. It should be appreciated that variations of the above are contemplated to be within the scope of the disclosure. The historical data may be evaluated over a given period of time (e.g., by day, month, year, years, seasons, etc.), or on-going. In some embodiments, context data may be used in lieu of, or in addition to, other information as described above as a basis for ordering and presenting a list.

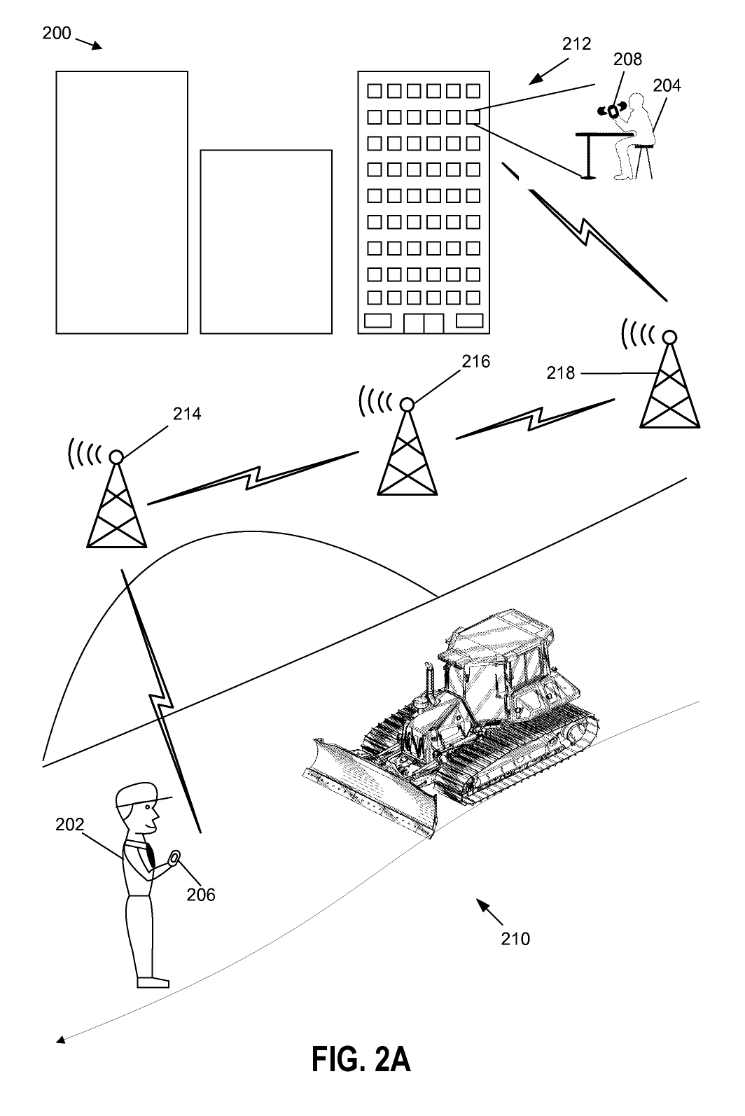

To highlight one benefit of ordering a displayed list of predetermined text messages based on intended recipient information, attention is directed to FIG. 2A, which shows a communications network 200 with two mobile device users 202 and 204 texting one another via mobile devices 206 and 208, respectively. One or both of the mobile devices 206 and 208 may be equipped with a smart texting system, and like the example depicted in FIGS. 1A-1B, an assumption is made that both mobile devices 206 and 208 are the same type for ease of illustration (though not limited as such). Further, though other mobile devices with different capabilities are contemplated to be within the scope of the disclosure, for ease of illustration, it is assumed that devices 106, 108, 206, and 208 are the same in the sense each has a scrollable display screen and limited alpha character input mechanisms, and each is equipped with an embodiment of a smart texting system. The text messaging in this example is implemented between users 202 and 204 of a construction company located at a job-site 210 and headquarters 212 (shown in FIG. 2A among other buildings), where the users 202 and 204 are associated via a business relationship (e.g., business partners, colleagues, fellow employees, etc.). The communication between sites 210 and 212 occurs over plural cell towers 214, 216, and 218. The content of the text messages that are exchanged between users 202 and 204 in this scenario (e.g., between business colleagues) is likely different, at least in some respects, to the content of the text messages exchanged between friends or family. In that respect, reference is made to FIG. 2B, which depicts an illustrative example of one of the mobile devices 206.

The mobile device 206 shown in FIG. 2B comprises a touch-type display screen 220, where a plurality of predetermined text messages 222A-222E (collectively, predetermined text messages 222) are presented on the display screen 220 and ordered by a smart texting system based on the applicability of each message at a given instance of time. In this example, the applicability of each message is based on the intended recipient information, and in particular, the texting to an intended recipient 204 whom is a business associate to the user 202. Some example predetermined text messages 222 are presented on the display screen 220, and include “Providing a status update” 222A, “Project on schedule” 222B, “Project delayed” 222C, “I have a question” 222D, and “Need time off” 222E. These messages 222 are provided as an illustrative, non-limiting example, and other and/or additional messages may be included.

In some embodiments, the choice of predetermined text messages 222 to present on the display screen 220 may be limited to a threshold number of most likely candidate messages and/or based on context data, as similarly described in association with FIGS. 1A-1B.

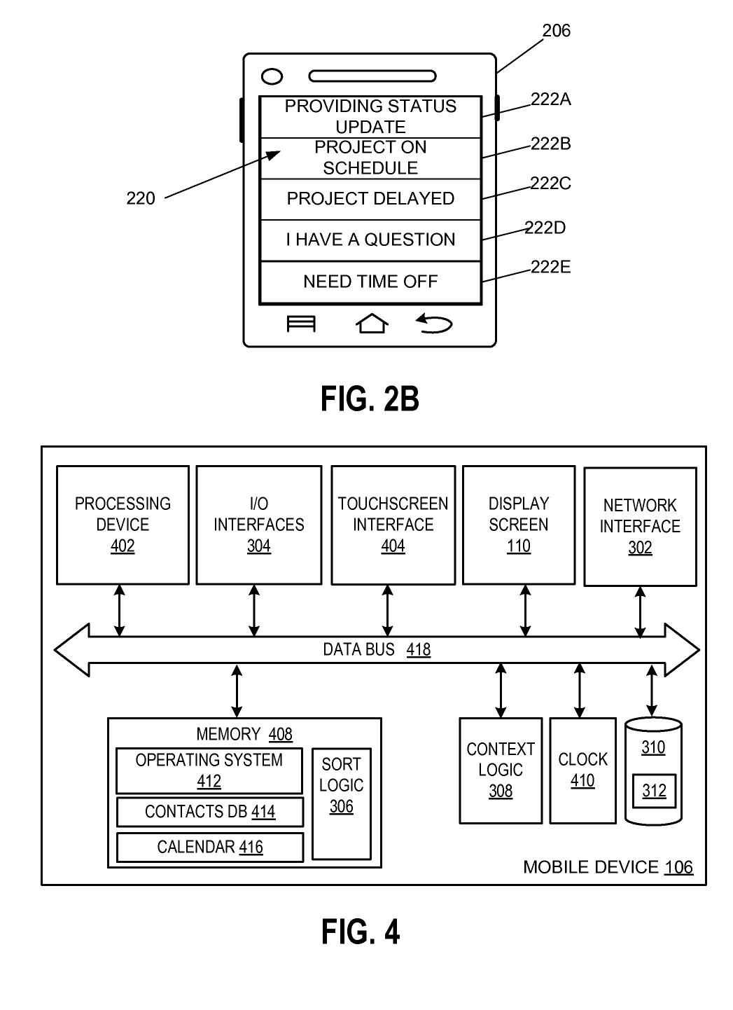

Having provided a broad overview of some example implementations using smart texting systems, attention is directed to FIG. 3 which illustrates an example environment and process flow 300 for loading predetermined text messages (e.g., 112 and 222 in FIGS. 1A-3B) to a mobile device, such as mobile device 106. The example mobile device 106 depicted in FIG. 3 comprises a network interface 302, input/output (I/O) interface 304, sort logic 306, context logic 308, and local storage 310 (e.g., memory, magnetic or optically-based persistent storage, etc.) having a message library 312 stored thereon. The mobile device 106 is detachably coupled to a local device 314, such as via the I/O interface 304. The local device 314 may comprise a personal computer, laptop, set-top box, personal digital assistant (PDA), cellular phone, or other computing device. For instance, the local device 314 is configured with at least memory 316, a processor 318, and an interface 320 that enables communication of data (e.g., uploading) from the local device 314 to another device, such as to the mobile device 106. The connection between the local device 314 and the mobile device 106 may comprise, for example, a micro-USB based connection used in conjunction with a cable extending between the mobile device 106 and the local device 314, or in some embodiments, may comprise a Bluetooth or near field communication (NFC) to transmit such information to the mobile device 106. Other mechanisms of communication between devices 106 and 314 are contemplated to be within the scope of the disclosure.

In one implementation, the local device 314 stores a plurality of predetermined text messages in memory 316. The predetermined text messages may be entered as input to the local device 314 (e.g., through keyboard or voice entry) by a user as a preliminary step to uploading the predetermined text messages to the mobile device 106. The predetermined text messages may be uploaded from the local device 314 to the mobile device 106 over a cable or wire (or via wireless connection in some embodiments) coupled between interface 320 and I/O interface 304, as indicated above. The uploading may be implemented as requested by a user (in connection with the coupling of the two devices 106 and 314), or automatically upon the sensing by the mobile device 106 (or local device 314) of the coupling of the devices 106 and 314. The uploading process may include a query (e.g., by the mobile device 106 or by the local device 314) as to whether the text messages to be uploaded are, at least in part, currently loaded in the mobile device 106, which, if already residing in the mobile device 106, duplicative messages are omitted from the upload. It should be appreciated by one having ordinary skill in the art that other components are included in the local device 314, yet omitted here for brevity.

The mobile device 106 is also coupled over one or more networks 322 to one or more network devices, such as server device 324. The server device 324 comprises a storage device (e.g., memory, persistent storage, etc.) 326 and other well-known components (e.g., network interface, processor, memory, application-specific software, etc.). The server device 324 stores a plurality of predetermined text messages in the storage device 326 for plural users. Each user may be uniquely identified by a MAC address of their communication device, phone number, IP address, or other identifiers capable of uniquely identifying the respective mobile device 106. For plural users of one phone, an additional identifier (e.g., social security number or portion thereof, name ID, etc.) may also be used to maintain a separate data structure of the predetermined messages for that particular user. The server device 324 accesses the plurality of predetermined text messages (of a given user) residing in the storage device 326 and provides the text messages 328 to the mobile device 106.

The network 322 comprises a cellular network, a wide area network, local area network, hybrid network (e.g., wired and wireless), or a combination of two or more of these types of networks.

In one embodiment, the predetermined text messages 328 are provided by the server device 324 to the mobile device 106 as an initial download, either prompted by the user or requested by the mobile device 106 automatically (e.g., as part of a polling mechanism and/or in response to certain events, such as idle time periods, off-hours (e.g., non-peak) periods, etc.), or a combination of these. For instance, the server device 324 may download the predetermined text messages to the mobile device 106 upon initial introduction of the mobile device 106 to the provider network. The predetermined text messages may have been provided by the user as an initial sign-up or subscription to the provider (e.g., via user entry in a web-screen or web-page of the provider). Updates in text messaging may be communicated by the user (e.g., via Web-page access to the provider), and automatically downloaded by the server device 324 (and/or downloaded upon user request or according to an automated mobile device request) subsequent to the upload to the web-site of the provider.

Note that the server device 324 and/or the mobile device 106 engage in a query, similar to that described above for the local device 314 and/or mobile device 106, to ensure that downloads of data already existing in or on the mobile device 106 (e.g., redundancy) is avoided. Note that both of these mechanisms may be employed at any given interval of time.

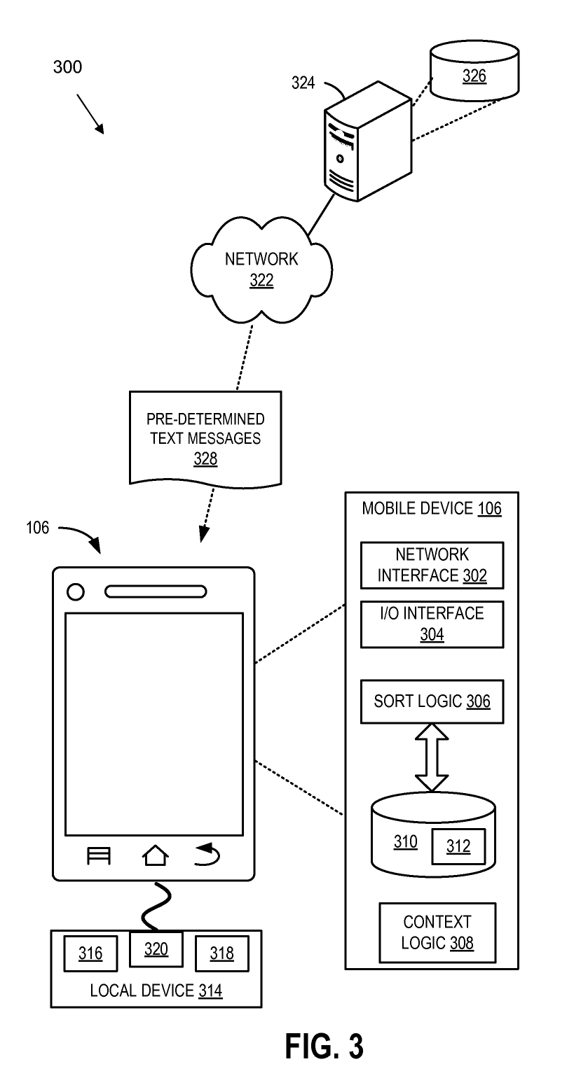

FIG. 4 illustrates an embodiment of the mobile device 106 described above. As described earlier, the mobile device 106 may be embodied as a smartphone, watch phone, tablet as well as any one of a wide variety of wired and/or wireless computing devices. As shown in FIG. 4, the mobile device 106 comprises a processing device 402, one or more I/O interfaces 304 (e.g., USB connection via a USB, micro-USB, or mini-USB connector, a Bluetooth connection, etc.), a touchscreen interface 404, a display screen 110, a network interface 302, memory 408, context logic 308, a clock 410, and local storage 310 comprising the message library 312, each coupled to one another over one or more busses, such as data bus 418. The memory 408 further comprises a native operating system 412, the sort logic 306, a contacts database 414, and a calendar application 416. Those skilled in the art should appreciate that the mobile device 106 includes other devices not shown for purposes of brevity. Further, functionality of one or more components depicted in FIG. 4 may be combined in a single module, or further distributed among additional modules.

The processing device 402 may include any custom made or commercially available processor, a central processing unit (CPU) or an auxiliary processor among several processors associated with the mobile device 106, a semiconductor based microprocessor (in the form of a microchip), a macroprocessor, one or more application specific integrated circuits (ASICs), a plurality of suitably configured digital logic gates, and other well-known electrical configurations comprising discrete elements both individually and in various combinations to coordinate the overall operation of the computing system.

The memory 408 can include any one of a combination of volatile memory elements (e.g., random-access memory (RAM, such as DRAM, and SRAM, etc.)) and nonvolatile memory elements. As indicated above, the memory 408 typically comprises the operating system 412, one or more native applications, emulation systems, or emulated applications for any of a variety of operating systems and/or emulated hardware platforms, emulated operating systems, etc. For example, the applications may include application specific software or other data structures, such as the sort logic 306 (explained further below), the contacts database 414, and the calendar 416, among others components.

The contacts database 414 may comprise a data structure (e.g., database, though not limited to a database format) with plural fields that help identify a contact that may later serve as a recipient of text messages or other communications from the user of the mobile device 106. Such fields may include recipient information such as name, address, phone number, classification of the recipient or association with the user (e.g., work or business, family, friend, fellow church member, supervisor, fellow employee, partner, officer, etc.), among other information that helps to identify or characterize the recipient.

The calendar 416 may comprise information fields pertaining to the dates and days for a given interval of time (e.g., one or more years), with fields associated with scheduled events or activities for, or of interest to, the user corresponding to one or more of the dates.

In accordance with such embodiments, the software or data structure components are stored in memory 408 and executed by the processing device 402. Note that in the context of this disclosure, in general, a non-transitory computer-readable medium stores programs for use by or in connection with an instruction execution system, apparatus, or device.

The touchscreen interface 404 is configured to receive input from a user, such as via the display screen 110, and provides such functionality as on-screen button icons, menus, keyboards, etc. that allow users to navigate user interfaces by touch. One of ordinary skill in the art should appreciate that the memory 408 can, and typically will, comprise other components which have been omitted for purposes of brevity.

The network interface device 302 comprises various components (e.g., transceiver logic) used to transmit and/or receive data over a networked environment.

The I/O devices 304 are configured to enable communication with local devices, such as local device 314.

The sort logic 306 cooperates with other components of the mobile device 106 to enable the ordering (e.g., sorting, where sorting and ordering are used interchangeably throughout the disclosure) of the plurality of predetermined and user-entered text messages stored in the local storage 310 in a data structure, such as the message library 312. In other words, the sort logic 306 maintains one or more lists of predetermined (predefined) text messages or common phrases in the message library 312. As indicated above, the mobile device 106 presents the list of messages on the display screen 110 in an ordered manner, from which a user may select when preparing to send a message to an intended recipient or reply to a received message from another user. The predetermined message list that makes up the message library 312 may be created off-line and then loaded into the mobile device 106 as explained in association with FIG. 3. In some embodiments, such as where the mobile device 106 supports limited text input capabilities (e.g., as provided as a touch-screen or otherwise user-manipulated graphic on the display screen 110 or buttons on the mobile device, even if cumbersome for the user and/or devoid of advanced text entry features), messages manually entered by the user may be appended to the message library 312. Such functionality enables growth and/or modification of the message library 312 over time.

To avoid scrolling through a large number of candidate messages when searching for a suitable message to send, certain embodiments of the sort logic 306 sort (e.g., change the order to differ from the order the list is received from the server 324 and/or local device 314, or in some embodiments, to change the order from the order typically stored in the mobile device 106 before accessing an intended recipient for purposes of text messaging) the list of predetermined text messages in the message library 312 such that the most applicable or likely choices are shown first to the user. A basis for the ordering of the list can be according to one or more factors. For instance, in one embodiment, the sort logic 306 considers (e.g., in some case, only considers) the number of times a given message has been previously selected by the user.

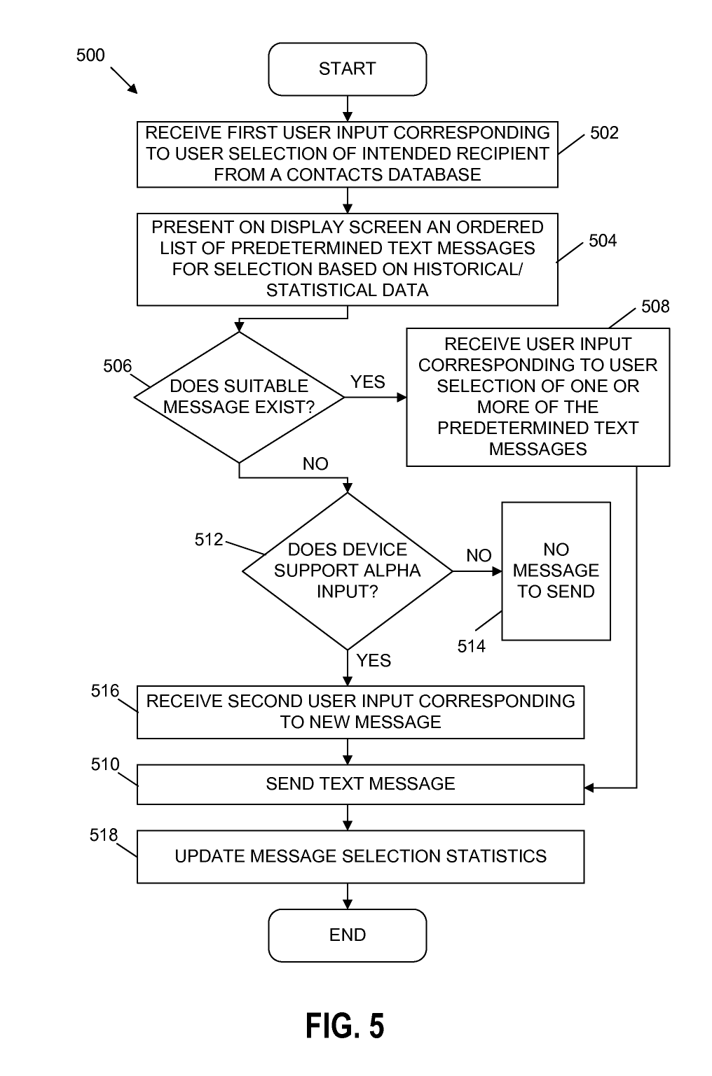

With continued reference to FIG. 4, attention is also directed to the flow diagram of FIG. 5, which illustrates an example sorting method embodiment 500 implemented by the mobile device 106 (e.g., using sort logic 306) that sorts a list of predetermined text messages according to usage history. In particular, the mobile device 106 receives a first user input corresponding to user selection of the intended recipient from a contacts database 414 (502). For instance, the selection may result from a touch-screen input (or non-screen button or otherwise) associated with a displayed list of contacts accessed from the contacts database 414.

Responsive to a recipient selection, the mobile device 106 presents on the display screen 110 an ordered list of predetermined text messages for selection, the ordering based on historical/statistical data (504). In other words, the sort logic 306 considers the number of times a given message has been previously selected by the user, and based on these statistics, the most frequently used (e.g., selected) messages are sorted to the beginning of the displayed list.

The mobile device 106 maintains a “waiting” state until there is an indication of whether a suitable message exists (506). An indication that a suitable message exists is that the mobile device 106 receives a user input corresponding to user selection of one or more of the predetermined messages (508). For instance, though single message entry selection has been described above, the user may also select multiple messages and concatenate them for delivery. The selection statistics are then updated independently, or in some embodiments, a new entry in the message library 312 may be created by the sort logic 306 representing the stacked messages (e.g., so the composite message can be selected by the user directly for future correspondence). The user input may comprise a touch-screen entry of the displayed message as highlighted or overlaid with a cursor, among other known input mechanisms.

The selected text message is then sent to the intended recipient (510), for instance based on selection of a “send” graphic displayed on the display screen after selection of the desired text message or via user selection of a suitable function (“send”) button.

Referring again to (506), if a suitable message does not exist, a determination is made whether the mobile device 106 supports alpha character input (512). One indication that the mobile device does not support such functionality is that the user selects a return button on the device to back-up to a prior screen, or in some embodiments, there is a time-out whereby no input is received after a threshold duration of time has elapsed, and the mobile device 106 returns to a former machine state, and hence no message is sent (514). An indication that alpha character input is supported is manifested as a receipt of a second user input corresponding to crafting a new message (516). For instance, the mobile device 106 may detect a prompt by the user (from user entry at the display screen 110 or via selection of a function button) that activates a displayed keyboard or otherwise enables manual entry. From there, the user may craft (e.g., create) a new message that is saved in the message library 312 upon sending the crafted message (510) (or in some embodiments, responsive to a displayed save button icon when the message is completed). Subsequent to sending the message (510), the mobile device 106 (e.g., sort logic 306) updates the message selection statistics (518).

Other factors or bases (e.g., in addition to, or in lieu of, historical/statistical bases) for sorting the list of predetermined text messages stored in the message library 312 are contemplated to be within the scope of the disclosure. In some embodiments, the sort logic 306 considers the identity of the addressed recipient (e.g., intended recipient) and/or details about the current sender's context. For instance, as explained in association with FIGS. 1A-2B, one approach is for the sort logic 306 to sort the list of predetermined text messages in the message library 312 on a per recipient basis, such that the top message choices (e.g., on the top of the displayed list) shown when addressing one recipient (e.g., a friend, such as depicted in FIG. 1B) may differ from the message choices presented at the top of the display screen 110 when addressing another recipient (e.g., a business colleague as shown in FIG. 2B). For instance, in the case where an intended recipient is a user's spouse, compared to the user's boss, it is unlikely a user would text his or her boss to ask, “what's for dinner,” just as it is unlikely that a user would text his or her spouse to ask for a raise.

Another basis, discussed to some extent above, is to sort the predetermined text messages of the message library 312 based on a recipient's classification in the user's contact database 414. For instance, candidate (predetermined) messages displayed when addressing “work” contacts may differ from candidate messages displayed when addressing “friend” contacts. In the latter instance, slang or humorous text messages may be included as candidate messages, whereas in the former, more “politically-correct” types of messages may be included as candidate messages.

Yet another basis for sorting may be through the use of contextual data collected from the sender's mobile device 106. For instance, the sort logic 306 may cooperate with the clock 410 (e.g., which may be implemented in hardware, software, or a combination of both) and/or the calendar 416 to collect information such as current time and/or date information. In some embodiments, the sort logic 306 may further cooperate with context logic 308. The context logic 308 may be configured with software, hardware, or a combination of both, and may comprise plural independent components. For instance, the context logic 308 may include well-known location logic, such as logic for performing GPS and/or triangulation functionality, movement logic (e.g., accelerometer, gyroscope, etc.), and/or other device or environmental sensing devices, such as audio sensors, temperature sensors, humidity sensors, etc. That is, the sort logic 306 may integrate information communicated by, or accessed from, the context logic 308 (among other logic of the mobile device 106) such as the current date/time, location (e.g., is the user away on travel), movement (e.g., is the user running, driving, etc.), what applications are running on the mobile device 106 (e.g., is the user listening to music), calendar appointments (e.g., is the user in a meeting) to provide a context as to what the user is doing at a given instance in time. Based on the user's current context, and equipped with the information of the intended recipient, the sort logic 306 can achieve a comprehensive evaluation of which messages are of the type the user is most likely to send.

It should be appreciated by one having ordinary skill in the art, in the context of the present disclosure, that any one or more of these factors may be used in any given implementation.

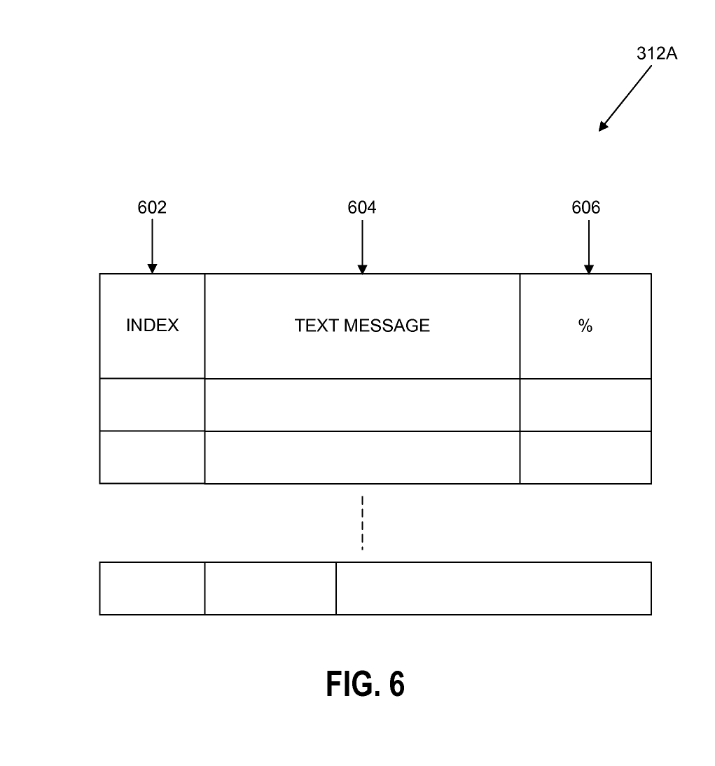

FIG. 6 illustrates one example embodiment of a message library 312A. The message library 312A comprises an index field 602 that identifies each row of messages in the library 312A with a unique identifier (e.g., 1, 2, 3, etc.), such as for easy reference by the sort logic 306. The message library 312A further comprises a text message field 604 for each predetermined text message downloaded or uploaded to the mobile device 106 and/or for each user-crafted text message, and a historical/statistical field 606 that renders a value for each message in the library 312A based on past selection history. For instance, the historical/statistical field 606 may comprise, in one embodiment, a percentage value that indicates the amount of times the user associated with the mobile device 106 selected the given message over a given interval of time. The interval of time may be on-going (e.g., always relative to the current time and looking back to the past history) from initial activation of the mobile device 106, or over a sub-set of the entire lifetime of the mobile device 106 (e.g., as defined and configured by the manufacturer of the mobile device, or as configured by the user).

In some embodiments, the message library 312A may be sorted as part of an on-going, periodic or aperiodic process performed by the sort logic 306, or in some embodiments, sorted in response to activation of text messaging by the user of the mobile device 106. The sorting functionality may be achieved by mirroring the message library 312A in working memory, such as a volatile memory portion of memory 408, and performing the sort in the working memory. The sorted version may be copied back to the local storage 310 or discarded (e.g., deleted or configured as writeable in working memory 408) after a threshold period of time, leaving the arrangement of the message library 312A in local storage 310 in-tact and unordered. Though shown in a single, tabular form in FIG. 6, the message library 312A may be configured using other types of data structures with further or fewer divisions of fields and/or tables.

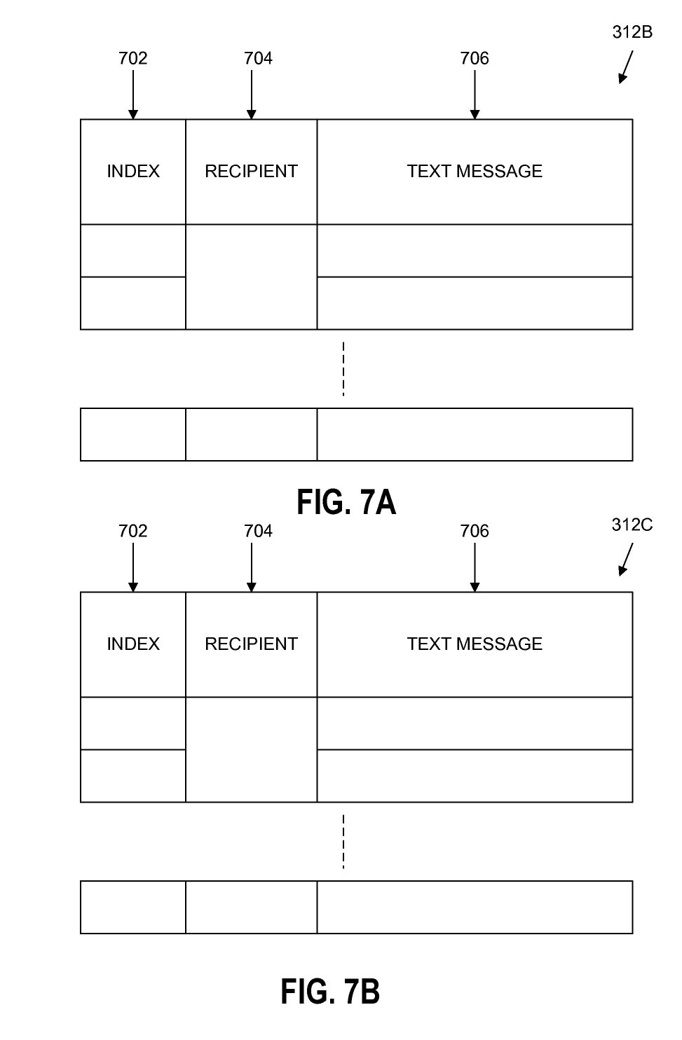

Referring to FIGS. 7A and 7B, shown are message libraries 312B and 312C, each with an index field 702, recipient identifier field (e.g., recipient “A” for message library 312B and recipient “B” for message library 312C) 704, and text message field 706 which includes fields for predetermined and/or user-crafted text messages. These libraries 312B and 312C may be the result of the sort logic 306 ordering a base message library that is unordered, the ordering implemented subsequent to the selection by the user of a recent intended recipient (e.g., two in this case) and copied back in sorted form (or deleted after a threshold period of time from working memory, as explained above). In some embodiments, the sorting may occur periodically (or aperiodically) and stored as an ordered message library 312A (and 312B), or in some embodiments, the base message library (e.g., in local memory 310) may be un-ordered, and mirrored in working memory of memory 408 to enable sorting by the sort logic 306, and once used, discarded after a threshold period of time or copied back to enable the storage of separate message libraries 312A and 312B (among others as time evolves and text messaging is implemented). Though shown in tabular form in FIG. 6, the message library 312A (and 312B) may be configured using other types of data structures with further or fewer divisions of fields and/or tables.

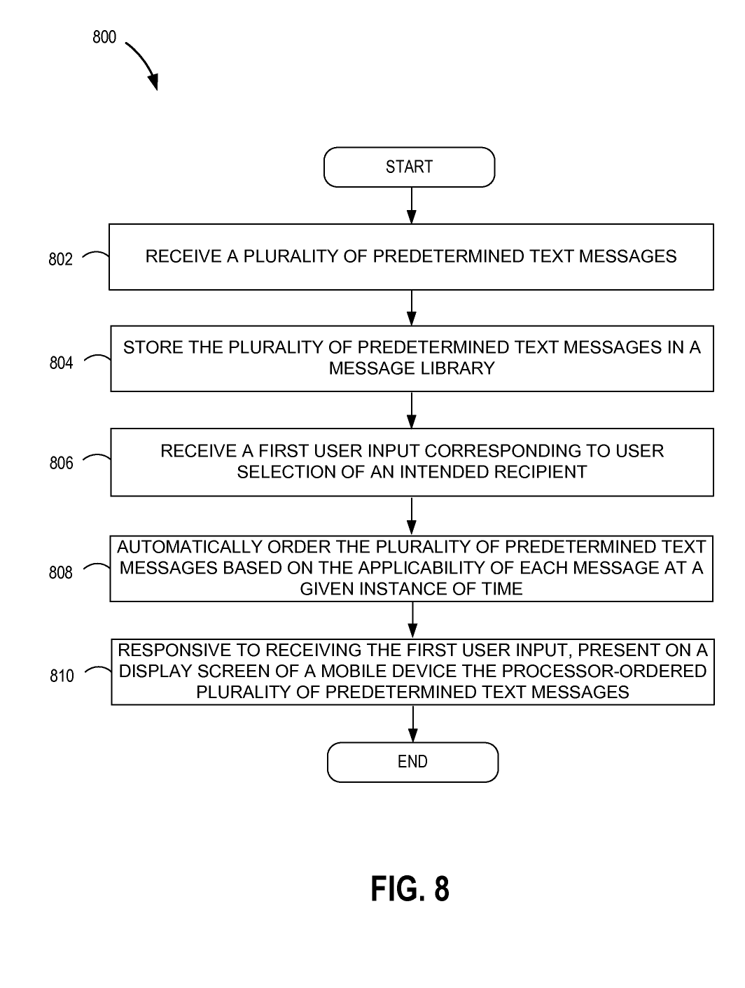

Having described certain embodiments of smart text systems, it should be appreciated, in view of the aforementioned description, that one smart texting method 800, depicted in FIG. 8 and employed by a mobile device (e.g., mobile device 106), comprises receiving a plurality of predetermined text messages (802); storing the plurality of predetermined text messages in a message library (804); receiving a first user input corresponding to user selection of an intended recipient (806); automatically ordering, by a processor, the plurality of predetermined text messages based on the applicability of each message at a given instance of time (808); and responsive to receiving the first user input, presenting on a display screen of a mobile device the processor-ordered plurality of predetermined text messages (810).

It should be appreciated that the blocks depicted in FIGS. 5 and 8 collectively correspond to smart texting methods. If embodied in software, each block depicted in FIGS. 5 and 8 represents a module, segment, or portion of code that comprises program instructions stored on a non-transitory computer readable medium to implement the specified logical function(s). In this regard, the program instructions may be embodied in the form of source code that comprises statements written in a programming language or machine code that comprises numerical instructions recognizable by a suitable execution system such as the mobile device 106. The machine code may be converted from the source code, etc. If embodied in hardware, each block may represent a circuit or a number of interconnected circuits to implement the specified logical function(s).

Although the flow diagrams of FIGS. 5 and 8 show a specific order of execution, it is understood that the order of execution may differ from that which is depicted in some embodiments.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

At least the following is claimed:

1. A mobile device, comprising:
a message library comprising a plurality of predetermined text messages;
a display screen;
a memory encoded with logic; and
a processor configured to execute the logic to:
receive a first user input corresponding to user selection of an intended recipient; and
responsive to receipt of the first user input, present on the display screen the plurality of predetermined text messages automatically ordered based on the applicability of each message at a given instance of time.

2. The mobile device of claim 1, wherein the applicability of each message is based on a history of past text message selections, wherein the plurality of predetermined text messages are presented in order from most frequently selected to least frequently selected.

3. The mobile device of claim 1, wherein the applicability of each message is based on a history of past text message selections involving the intended recipient, wherein the plurality of predetermined text messages are presented in order from most frequently selected to least frequently selected with respect to the intended recipient.

4. The mobile device of claim 1, wherein the applicability of each message is based on an identity of the intended recipient, wherein the plurality of predetermined text messages are presented in a different order depending on the identity of the intended recipient.

5. The mobile device of claim 1, wherein the applicability of each message is based on a stored classification of the intended recipient, wherein the plurality of predetermined text messages are presented in a different order depending on the stored classification of the intended recipient.

6. The mobile device of claim 5, wherein the stored classification comprises one or a combination of an association based on friend, family, or business.

7. The mobile device of claim 1, wherein the applicability of each message is based on data collected from the mobile device.

8. The mobile device of claim 7, wherein the data comprises a current date or time.

9. The mobile device of claim 7, wherein the data comprises a location of the mobile device or a status of movement of the user of the mobile device.

10. The mobile device of claim 7, wherein the data comprises information corresponding to stored calendar appointments associated with the user of the mobile device.

11. The mobile device of claim 1, wherein the processor is further configured to select at least one of the plurality of predetermined text messages responsive to user selection from the display screen and cause the delivery of the selected one of the plurality of predetermined text messages.

12. The mobile device of claim 1, wherein the applicability of each message is based on a combination of history of past text message selections, information corresponding to the intended recipient, and data collected from the mobile device.

13. The mobile device of claim 1, wherein the ordering is implemented subsequent to the receipt of the first user input.

14. The mobile device of claim 1, wherein the processor is configured to execute the logic to modify the message library responsive to a second user input received from a displayed alpha character keyboard.

15. The mobile device of claim 1, wherein the processor is configured to receive the message library from a second device.

16. A method, comprising:
receiving a plurality of predetermined text messages;
storing the plurality of predetermined text messages in a message library;
receiving a first user input corresponding to user selection of an intended recipient;
automatically ordering, by a processor, the plurality of predetermined text messages based on the applicability of each message at a given instance of time; and
responsive to receiving the first user input, presenting on a display screen of a mobile device the processor-ordered plurality of predetermined text messages.

17. The method of claim 16, wherein the applicability of each message is based on a history of past text message selections, wherein the plurality of predetermined text messages are presented in order from most frequently selected to least frequently selected.

18. The method of claim 17, wherein the applicability of each message is further based on information corresponding to the intended recipient, wherein the plurality of text messages are presented in a first order for a first recipient and a second order for a different recipient.

19. The method of claim 18, wherein the applicability of each message is further based on user-contextual data collected from the processor.

20. A system, comprising:
a message library comprising a plurality of predetermined text messages;
a display screen;
a memory encoded with logic; and
a processor configured to execute the logic to:
receive a first user input corresponding to user selection of an intended recipient;
automatically order the plurality of predetermined text messages based on the applicability of each message at a given instance of time; and
responsive to receiving the first user input, present on the display screen the ordered plurality of predetermined text messages.
